(19) United States
(12) Patent Application Publication
(10) Pub. No.: US 2016/0249623 A1
(43) Pub. Date: Sep. 1, 2016

(54) METHODS FOR DISPENSING SALT-FREE HYPOCHLOROUS ACID FOR HAND-SANITIZING

(71) Applicant: Walter Warning, Deland, FL (US)

(72) Inventor: Walter Warning, Deland, FL (US)

(21) Appl. No.: 15/054,360

(22) Filed: Feb. 26, 2016

Related U.S. Application Data
(60) Provisional application No. 62/121,952, filed on Feb. 27, 2015.

(51) Int. Cl. A01N 59/00; C01B 11/04

(52) U.S. Cl. CPC A01N 59/00; C01B 11/04

(57) ABSTRACT

Taught herein is a method and means of sanitizing a person's hands using an anti-microbial, salt-free, non-allergenic, non-toxic hypochlorous acid (HOCI) hand-sanitizing compound applied to a user's hand by a hand-sanitizer dispenser. The dispenser is either automatic or manual and is operated from a wall-mounted dispenser, a table-top-mounted or a free standing unit. The HOCI hand-sanitizer kills all viruses, bacteria, mold and spores within seconds, the longest kill-time being HIV in less than 1 minute. The non-toxicity of HOCI and its dispenser provides for its use in medical facilities, schools (all levels), food preparation, food service, the hospitality industry, agriculture, meat processing, handling areas for seafood, fruits and vegetables, and in all places where an item, such as a pen provided for customer's signature, is used by more than one person. HOCI is free of any allergens or harmful chemicals, such as the phthalates, benzalkonium chloride, triclosan or parabens.

### CROSS-REFERENCE TO RELATED APPLICATIONS

This is a Non-Provisional Application of Provisional Application 62/121,952, filed Feb. 27, 2015.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to a method of hand-sanitizing and, more particularly, to a method for hand-sanitizing using a hand-sanitizing dispenser designed for dispensing an anti-microbial, salt-free, non-allergenic, non-toxic hypochlorous acid (HOCI) hand-sanitizing compound.

The background information discussed below is presented to better illustrate the novelty and usefulness of the present invention. This background information is not admitted prior art.

Using hand antiseptics, hand disinfectants, or hand sanitizers are supplements or alternatives to hand washing with soap and water. University of Virginia Medical School researchers concluded that hand-sanitizing is more effective against fighting the common cold than hand-washing. A controlled study of 200 workers at FedEx in 2004 showed that placing hand-sanitizing dispensers in an office and educating workers about their use resulted in a 21% reduction in absenteeism. Controlled studies showed an even greater reduction in absenteeism (51%) in elementary schools and college dormitories (43%).

The active ingredient in hand-sanitizers may be isopropyl alcohol (isopropanol), ethanol, n-propanol, or povidone-iodine. Inactive ingredients in alcohol rubs typically include a thickening agent such as polyacrylic acid for alcohol gels, humectants such as glycerin for liquid rubs, propylene glycol, and essential oils of plants. The level of alcohol in alcohol-based hand-sanitizers varies between 60% and 85% and must be over 60% to be effective. There are some serious concerns with alcohol hand-sanitizers. If ingested by children, they could be seriously harmed by alcohol poisoning. It is known that alcohol strips the skin of the outer layer of oil, which may have negative effects on barrier function of the skin.

Common non-alcohol, rinse-free hand-sanitizers use either small concentrations of the nitrogenous cationic surface-acting agent benzalkonium chloride, the chlorinated aromatic compound triclosan, or povidone-iodine. Some products claim to kill microorganisms naturally, although these claims are not substantiated in any FDA monograph. The main killing function of benzalkonium chloride is to dissolve the outer covering of the bacterial cells, but is about as bad for our cells as it is for the microbes. Benzalkonium chloride also has been found to increase the irritation within the mucosal lining and can aggravate allergic reactions. Laboratory studies have shown lingering benzalkonium chloride may be associated with antibiotic resistance in MRSA. In laboratory studies, triclosan has been shown to disrupt hormones, which isn't surprising as it is a common ingredient in pesticides, and can encourage the growth of drug-resistant bacteria or “superbugs as reported by the Natural Resources Defense Council. Triclosan is capable of quickly being absorbed into the skin and entering the blood stream and once there, it is known to cause various side effects like cancer, allergies, hormonal and neurological ill effects, muscle weakness, and infertility. A 2014 study by the American Chemical Society found that triclosans spurred the growth of breast cancer cells, and studies at the University of California at Davis found they can kill brain cells. Triclosan has been shown to accumulate in bio-solids in the environment, is one of the top seven organic contaminants in waste water according to the National Toxicology Program triclosan, leads to various problems with natural biological systems, and when combined with chlorine (e.g. from tap water) produces dioxins, a probable carcinogen in humans. The FDA says they're contributing to making bacteria resistant to antibiotics, and helping create superbugs such as MRSA. Triclosan, which degrades to dioxins in the body, has a long list of health red flags. Hand sanitizers often contain chemicals called parabens that prevent the growth of bacteria, but they have been linked to health problems including cancer, neurotoxicity, endocrine disruptions, and skin irritation. Parabens, which include ethylparaben, butylparaben, methylparaben and propylparaben, are found in many personal care products such as shampoo, conditioner, body wash, soaps, hand sanitizers and lotions as an antibiotic. Parabens have been linked to endocrine disruption, skin irritation, reproductive toxicity, immunotoxicity and cancer. Parabens also mimic estrogen by binding to estrogen receptors on cells, and they increase the expression of genes regulated by estradiol, a natural form of estrogen. Some people believe in sanitizing their hands before preparing food. However, the chemical phthalate that is used to convey a pleasant scent to many hand-sanitizers can easily leach off of your hands onto the food being prepared. The HOCI compound contains no phthalates that can easily leach into food and then onto your body. A study conducted by the CDC (Center for Disease Control) found that children now showed 20 times more phthalate metabolite in their bodies than at any time in the past. The Swan study showed that women exposed to excessive phthalates gave birth to boys who suffered from a wrongly positioned anal opening and posed a higher risk of being infertile or having lower fertility than normal.

Hand-sanitizers are dispensed using various types of dosing systems. For hospitals the hand-sanitizers are designed to deliver a measured amount of the product. They can be dosing pumps screwed onto a bottle or dispensers designed for use with refill bottles. Dispensers for surgical hand disinfection are usually equipped with elbow controlled mechanisms or infrared sensors to avoid any contact with the pump. For general use, a hand-sanitizer dispenser is a device that, when manipulated or triggered appropriately, yields the hand-sanitized usually in small, single-use quantities. The dispensers can be manually operated by means of a handle, or can be automatic.

### SUMMARY

The inventive concept taught herein is a method of sanitizing a person's hands by treating the hands with a fully effective anti-microbial, salt-free liquid hypochlorous acid (HOCI) hand-sanitizing solution that is applied to a user's hand by a hand-sanitizer dispenser. In particular, the present invention is directed towards a salt-freehand-sanitizing method that sprays or dispenses an amount of sanitizing liquid HOCI onto a user's hands. The dispensing is either automatic or manual and is operated from a wall-mounted dispenser, a table-top-mounted or a free standing unit.

The present inventor invented and patented an electrolysis chamber (see U.S. Pat. No. 8,486,236) for the production of salt-free solutions, The elimination of salt in products, is important due to the widely appreciated fact that salt causes crusting to occur leading to malfunction of a unit meant to dispense such a solution. According, the present Inventor further conceived an inventive concept of producing a salt-freehand-sanitizing that is non-toxic to humans to be used in combination with as salt-freehand-sanitizing dispenser. The salt-freehand-sanitizing is salt-free hypochlorous acid (HOCI). HOCI is a 100% non-toxic, solution having anti-microbial properties and is free of any allergens or harmful chemicals.

HOCI kills all viruses, bacteria, mold and spores within seconds, the longest kill-time being HIV (Human Immunodeficiency Virus) in less than 1 minute. The fully anti-microbial property of HOCI far surpass the most commonly used alcohol based sanitizers that have limited killing coverage. Moreover, as discussed above, alcohol based products have health hazards for the user, in part due to the absorption of the alcohol into the blood stream (as published by the FDA). The non-toxicity of HOCI and its dispenser provides for its use in medical facilities, schools (all levels), food preparation, food service, the hospitality industry, agriculture, meat processing, handling areas for seafood, fruits and vegetables, and in all places where an item, such as a pen provided for customer's signature, is used by more than one person.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a perspective view of an automatic liquid mist/spray dispenser dispensing a mist of liquid hypochlorous acid.

FIG. 2 is a perspective view of an automatic liquid dispenser dispensing a stream or squirt of liquid hypochlorous acid.

FIG. 3 is a perspective view of a manual table-top dispenser dispensing liquid hypochlorous acid.

FIG. 4 is a perspective view of an automatic table-top dispenser dispensing liquid hypochlorous acid.

FIG. 5 is a front quarter elevated isometric view of an electrolysis chamber.

FIG. 6 is a rear quarter upward view of the electrolysis chamber, as illustrated in FIG. 5.

It should be understood that the drawings are not necessarily to scale. In certain instances, details which are not necessary for an understanding of the present invention or which render other details difficult to perceive may have been omitted.

### REFERENCE CHARACTERS AND THE PARTS TO WHICH THEY REFER

2 Electrolysis Chamber.
4 Electrode contacts.
6 First end product outlet port.
8 Second end product outlet port.
10 First initial product inlet port.
12 Second initial product inlet port.
14 Third end product outlet port.
49 Actuator knobs.
50 Wall mountable automatic spray dispenser.
55 A spray of liquid hypochlorous acid (HOCI).
60 Wall mountable automatic squirt or stream dispenser.
65 A squirt or stream of liquid hypochlorous acid (HOCI).
70 Manual table-top dispensing dispenser.
75 Manual dispenser manual control.
80 Automatic table-top dispenser.
85 Dispenser support.
90 A hand of a person.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

The principles derived from the present inventive concept include a non-toxic hand-sanitizer dispensed in measured amounts from a hand-sanitizing dispenser. The hand-sanitizer is a salt-free, non-toxic, anti-microbial compound of hypochlorous acid (HOCI). HOCI is prepared by combining water, as a first initial product, and a salt in water solution, as a second initial product in an electrolysis chamber that separates the initial products resulting in HOCI as a first end product, sodium hydroxide as a second end product, and brine solution as a third end product. HOCI is a 100% non-toxic, solution having anti-microbial properties and is free of any allergens or harmful chemicals, such as the phthalates, benzalkonium chloride, triclosan or parabens, as discussed above.

The hand-sanitizing dispenser can be of several forms that are adapted for use with HOCI. When HOCI is dispensed in liquid form, it can be dispensed from a squeeze bottle or pump, which can be disposable. Manual dispensers of liquid HOCI often consist of a container with a dispensing button or a lever that pulls forward and squeezes the sanitizer out. The HOCI may also be dispensed by automatic dispensers that can be either electric or battery-powered. Touch-free dispensers dispense the liquid when a sensor detects motion under its nozzle. The electronic components of an automatic soap dispenser can allow for a timing device or signal (sound, lights, etc.) which can indicate to the user whether they have washed their hands for the correct amount of time or not. Such hands-free dispensers for liquid salt-free hand-sanitizing have particular virtues for operating theatres and treatment rooms. Both manual and automatic dispensers are able to dispense the HOCI as a liquid squirt, a fine mist spray, or as foam. Foam dispensers have dual pumps that when used move both air and liquid, injecting both together through small openings to create a foamed material. They can be found in both manual and automatic varieties. The hand-sanitizing dispensers of the present invention are constructed to be wall-mounted, supported by their own support-stand, and in a table top form. The hand-sanitizing dispensers of the present invention also are constructed to be portable and purse-sized.

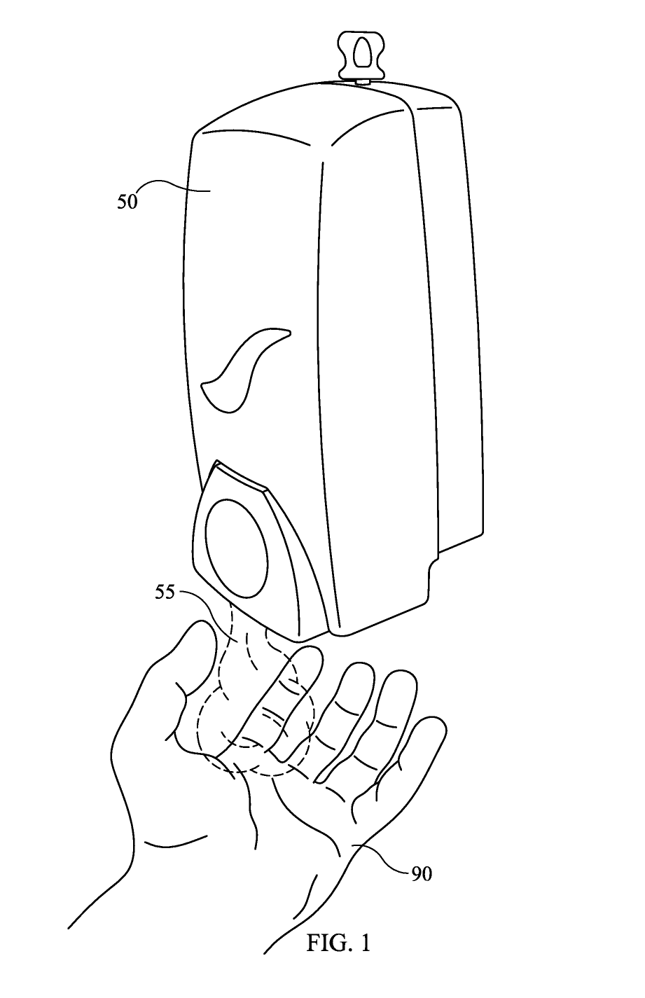

Turning now to the drawings, FIG. 1, a perspective view, illustrates wall-mounted automatic HOCI liquid dispenser 50 dispensing a measured amount of liquid HOCI onto a user's hand 90 as cloud-like fine mist spray 55. It should be understood that the exemplar wall mounted unit can be mounted by any means that will position the dispenser for its intended use.

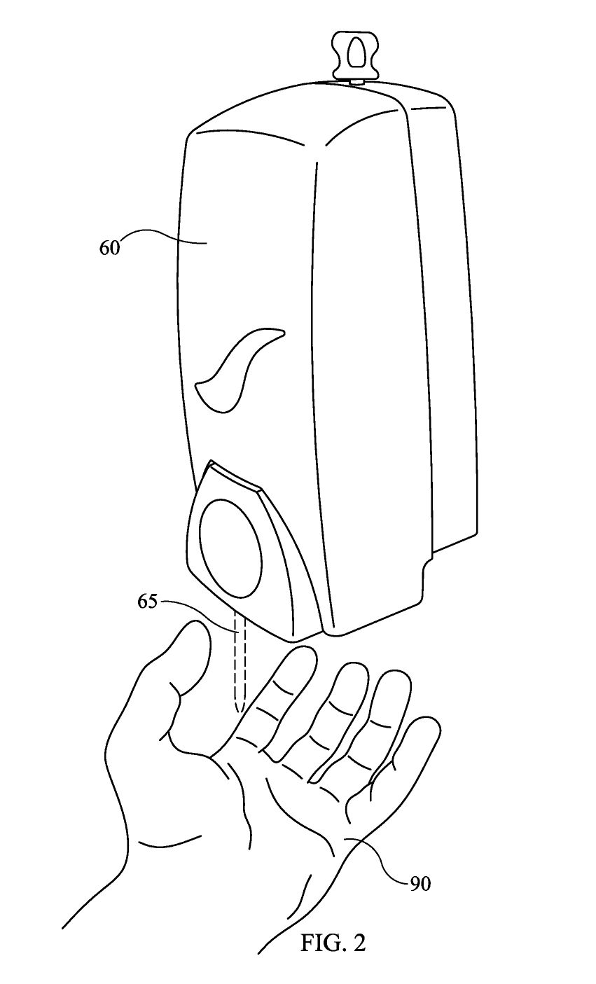

FIG. 2 illustrates wall-mounted automatic HOCI liquid dispenser 60 dispensing a measured amount of liquid HOCI onto a user's hand 90 as stream of liquid 65. Automatic dispensers are powered by any power source that is effective, such as traditional electric, battery, or solar power, for example. Automatic dispensers often referred to as “touch-free” dispensers dispense liquid HOCI when a functionally coupled interactive motion sensor detects the motion that will activate the dispenser. Such motion may be when a user places his or her hand under the dispenser's nozzle. The electronic components of an automatic sanitizer dispenser allow for a timing device or signal (sound, lights, etc.) that indicates to the user when they have washed their hands for the correct amount of time or not. Such hands-free dispensers for liquid salt-free hand-sanitizing have particular virtues for operating theatres and treatment rooms.

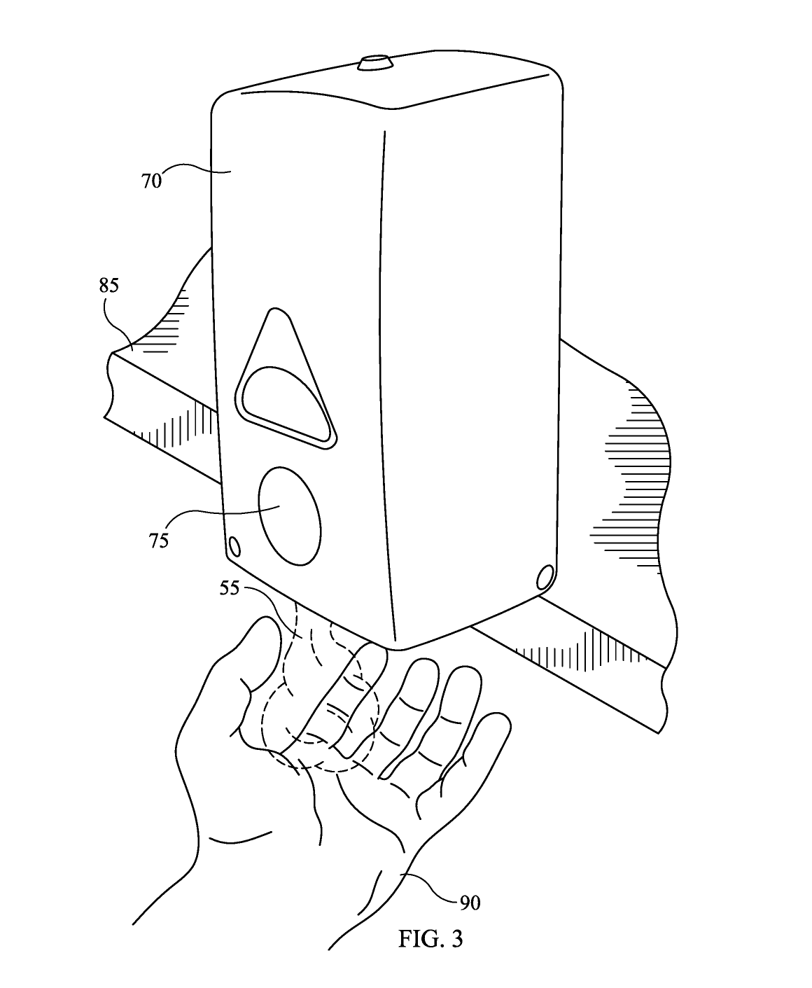

FIG. 3, a perspective view, illustrates manually operated table-top HOCI liquid dispenser 70 designed to dispense liquid hypochlorous acid onto a user's hand 90 when the dispenser is activated using manual dispenser manual control 75, which could be a button or a knob, for example. In the illustration, dispenser 70 is shown dispensing a spray of HOCI, although it should be understood that table-top units are available to dispense either a spray or stream or HOCI. Manual dispensers are especially desired in locations where the availability of power is not certain and are available in both the mist or squirt modes of dispensing. Table-top type dispensers are especially useful when the dispenser is being used in a situation that involves repeated movement of the device or when it would be difficult to use the more permanent wall-hanging styles, such as in a tent or even outdoors. Table-top type dispensers are capable of being attached to a shelf, such as shelf 85, as illustrated, or of being a free-standing unit. It is also to be understood that there are various positions for the dispenser outlet. As illustrated, the HOCI outlet is located within the bottom surface of the dispenser, although there are dispenser styles that offer outlets on the front or either side of the dispenser when the unit is a free-standing unit.

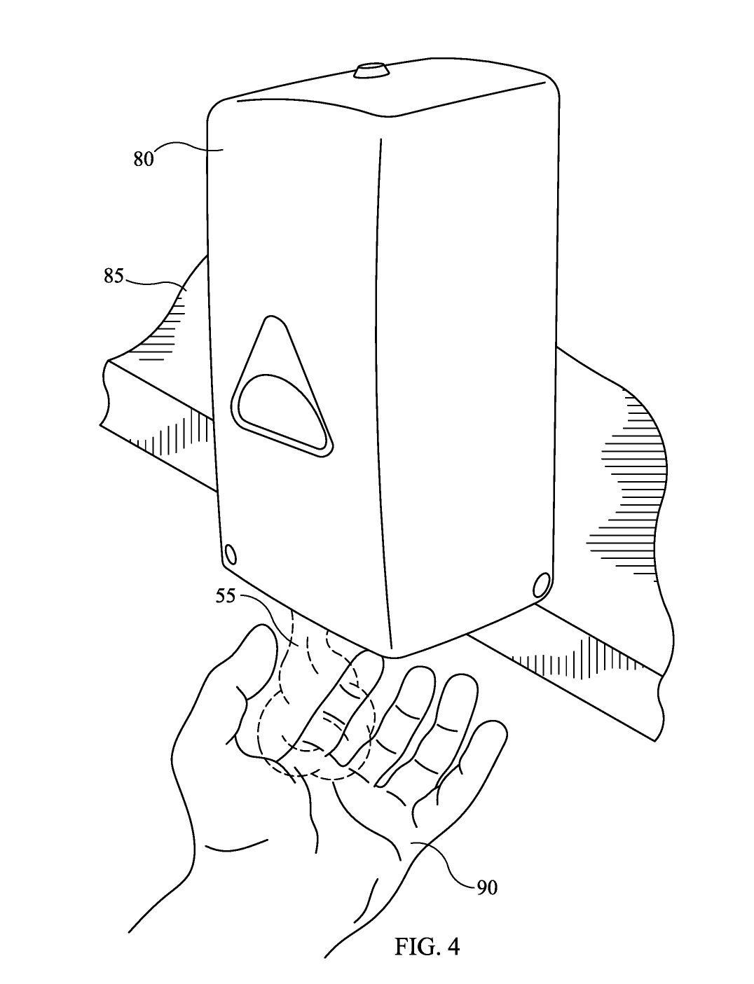

FIG. 4 illustrates automatic table-top liquid dispenser 80 dispensing spray 55 liquid hypochlorous acid onto a hand 90 of a user.

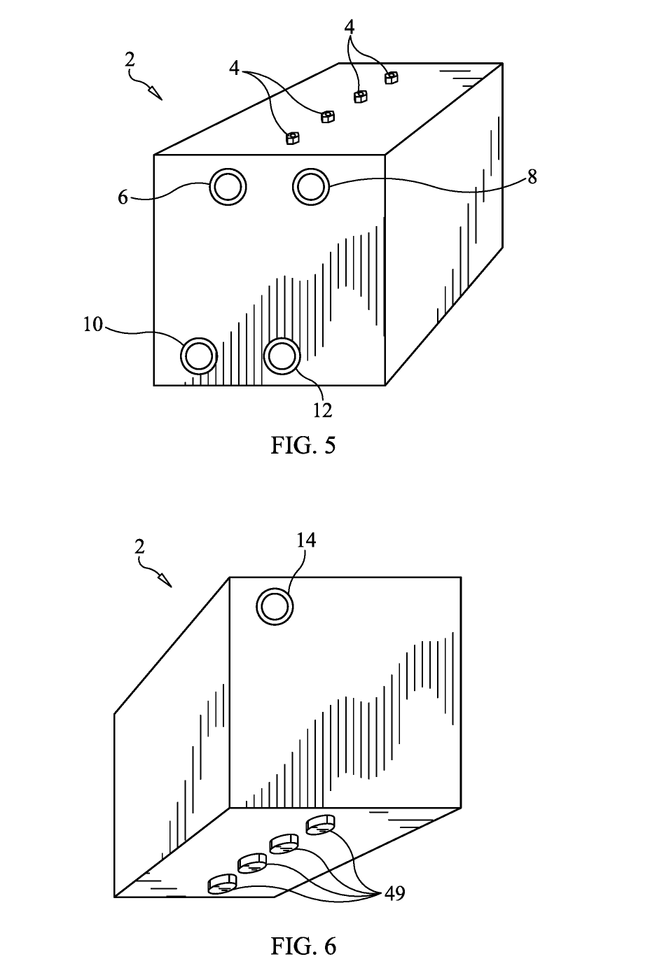

FIG. 5 illustrates a front quarter elevated isometric view of electrolysis chamber 2 having electrode contacts 4, first initial product inlet port 10 and second initial product inlet port 12 for initial products for the electrolysis process; first end product outlet port 6, and second end product outlet port 8. FIG. 6 illustrates a rear quarter upward view of electrolysis chamber 2 showing third end product outlet port 14 for the products resulting from the electrolysis and actuator knobs 49 that set the flow rate of the initial products. One example of these products may be water as a first initial product and salt in water solution as a second initial product; with HOCI as a first end product, sodium hydroxide as a second end product, and brine solution as a third end product.

Following the principles of the inventive concept, HOCI solution is also offered as packaged in bags with a spray nozzle assembled but, if preferred it is also available packaged in plastic containers with a pull seal and valve assemble included.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A method of sanitizing a person's hands, comprising:
providing a non-toxic, anti-microbial, salt-free, HOCI (hypochlorous acid) sanitizer compound,
providing a dispenser constructed for dispensing said HOCI sanitizer compound, and
dispensing an effective amount of HOCI sanitizer compound required for sanitizing a person's hands,
wherein the person's hands are sanitized using said non-toxic, anti-microbial, salt-free, HOCI sanitizer compound.

2. The method of sanitizing a person's hands, as recited in claim 1, wherein said HOCI compound is dispensed via a manual hand-sanitizer dispenser.

3. The method of sanitizing a person's hands, as recited in claim 1, wherein said HOCI compound is dispensed via an automatic hand-sanitizer dispenser.

4. The method of sanitizing a person's hands, as recited in claim 1, wherein said HOCI compound is dispensed via a table-top hand-sanitizing dispenser.

5. The method of sanitizing a person's hands, as recited in claim 1, wherein said HOCI compound is a liquid.

6. The method of sanitizing a person's hands, as recited in claim 113. The method of sanitizing a person's hands, as recited in claim 1, where said compound is a solution.

7. The method of sanitizing a person's hands, as recited in claim 1, wherein said HOCI compound is allergen free.

8. The method of sanitizing a person's hands, as recited in claim 1, wherein said HOCI compound contains no harmful chemicals.

9. The method of sanitizing a person's hands, as recited in claim 1, wherein said HOCI compound is safe to bring into contact with food.

10. The method of sanitizing a person's hands, as recited in claim 1, wherein said HOCI compound does not contain benzalkonium chloride

11. The method of sanitizing a person's hands, as recited in claim 1, wherein said HOCI compound contains no phthalates.

12. The method of sanitizing a person's hands, as recited in claim 1, wherein said HOCI compound does not contain triclosan.

13. The method of sanitizing a person's hands, as recited in claim 1, wherein said HOCI compound does not contain parabens.

14. The method of sanitizing a person's hands, as recited in claim 1, where said compound is manufactured in an electrolysis chamber said chamber providing inlet ports for the initial products of a salt in a water solution and water; and providing a outlet ports for the electrolysis product of a hypochlorous acid (HOCI), sodium hydroxide (NaOH), and by-products such as brine.

15. The method of sanitizing a person's hands, as recited in claim 1, wherein said anti-microbial properties kill virus, bacteria, mold and spores in less than one minute.

16. A hand-sanitizer and a hand-sanitizer dispenser combination, comprising:
a hand-sanitizer being a non-toxic, non-allergenic, anti-microbial, salt-free, HOCI (hypochlorous acid) compound, and
a hand-sanitizer dispenser structured to dispense effective amounts of said hand-sanitizer.

17. The hand-sanitizer and a hand-sanitizer dispenser combination, as recited in claim 16, wherein said HOCI compound is a liquid.

18. The hand-sanitizer and a hand-sanitizer dispenser combination, as recited in claim 16 wherein said dispenser is an HOCI liquid-dispensing hand-sanitizer dispenser.

19. The hand-sanitizer and a hand-sanitizer dispenser combination, as recited in claim 16, wherein said hand-sanitizer dispenser may be an automatic or manual hand-sanitizer dispenser.

20. An HOCI (hypochlorous acid) sanitizer compound, comprising:
an HOCI liquid manufactured in an electrolysis chamber,
said chamber providing a single inlet port for initial products of a salt in a water solution and water;
said chamber further providing a single outlet port for electrolysis products of hypochlorous acid (HOCI) and sodium hydroxide (NaOH), and for by-products such as brine (salt in a water solution),
said HOCI having anti-microbial properties,
said anti-microbial properties realizing killing virus, bacteria and mold and spores in less than one minute, and
where said HOCI compound is non-toxic, non-allergenic and salt-free and is dispensed in a hand-sanitizer dispenser.
